(19) United States
(12) Patent Application Publication
(10) Pub. No.: US 2018/0283710 A1
(43) Pub. Date: Oct. 4, 2018

(54) PORTABLE AIR COOLING UNIT

(71) Applicant: JOSEPH A. FRENCH, RIVER OAKS, TX (US)

(72) Inventor: JOSEPH A. FRENCH, RIVER OAKS, TX (US)

(21) Appl. No.: 15/475,043

(22) Filed: Mar. 30, 2017

(51) Int. Cl. F24F 5/00; B60H 1/00; B60H 1/32; A45F 3/04; B62B 9/00; A01D 34/00

(52) U.S. Cl. CPC F24F 5/0035; F24F 5/0021; B60H 1/00264; B60H 1/3202; A45F 2003/001; B62B 9/00; A01D 34/001; F24F 2221/12; A45F 3/04

(57) ABSTRACT

The present application describes a portable air cooling unit configured to provide a cooling effect upon a user through the removal of heat from an air flow. The unit includes a fan unit configured to generate the air flow. The air flow is sent through a storage unit that holds one or more cooling mediums. An internal tray is located in the storage unit and is configured to translate vertically in relation to the type and amount of cooling medium. The air flow is selectively directed through the cooling mediums to provide a dual stage cooling process prior to leaving through a flexible exhaust duct. Warm air enters the storage unit and leaves through the exhaust duct which is directed for the best cooling use as determined by the user.

### BACKGROUND

### 1. Field of the Invention

The present application relates generally to a cooling device, and in particular to a portable cooling device that incorporates evaporative cooling methods to generate a reduced temperature airflow. The cooling device includes internal components that optionally move in relation to water level.

### 2. Description of Related Art

Individuals outside are susceptible to the effects of heat. Many types of methods are used to provide a cooling effect on the body. The body itself sweats which causes an evaporative cooling effect on the skin in an attempt to naturally cool the body. Similar types of efforts are used and generated over time. Manually operated fans are used to generate a manufactured breeze that cools the body. This is especially helpful where the ambient air is stagnant.

Other advancements have been made using electronically controlled devices. These devices often incorporate a motorized fan to generate an air flow that is passed through a cooling medium. The cooling medium may be either many things, but commonly liquid water and ice are used. Where ice is used, the ice quickly melts and becomes a liquid. Forced air does not engage the liquid water in the same manner as the ice. With the ice, the air flow is forces around and through the ice providing a more enhanced cooling effect. With water, the forced air skips off the surface. To try and remedy this issue, some devices incorporate a pump system to move the water into the path of the air flow. In operation, the liquid water is often mixed in with the distributed air flow to the individual which in turn causes undesired saturation on the individual. In other types of similar devices, the precise water level is important in keeping the water moving appropriately. If water level changes too much, the system fails to work. Additionally, a system that combines the capabilities of both liquid water and ice in different scenarios seems to be missing.

Although strides have been made with respect to cooling devices, considerable shortcomings remain. A system is needed that provides longer lasting cooling effects for a user and is designed to adjust to differing amounts and combinations of both liquid and solid cooling mediums.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a portable air cooling unit within a bag according to an embodiment of the present application;

FIG. 2 is an enlarged perspective view of the portable air cooling unit of FIG. 1.

FIGS. 3 and 4 are a perspective view and side view, respectively, of an embodiment of the portable air cooling unit of FIG. 1.

FIGS. 5 and 6 are an alternative perspective view and side view, respectively, of the portable air cooling units of FIGS. 3 and 4.

FIG. 7 is perspective view of an alternative embodiment of the portable air cooling unit of FIG. 1.

FIGS. 8-12 are perspective views of components within the portable air cooling unit of FIG. 7.

FIGS. 12 and 14 are perspective views of a portion of the portable air cooling unit of FIG. 7.

FIGS. 15 and 16 are perspective views of a barrier used in the portable air cooling unit of FIG. 1.

FIGS. 17-23 are sides views of the portable air cooling unit of FIG. 1 used in various exemplary manners.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system in accordance with the present application overcomes one or more of the above-discussed problems commonly associated with existing methods and devices used to generate a cooling effect upon the body. Specifically, the system of the present application is configured to provide a forced air cooling effect upon an individual. The system is operable with the use of either solid cooling mediums (i.e. ice) or liquid cooling mediums (i.e. liquid water). The system is configured to adapt to the amount of liquid inside so as to maintain the ability of incorporating a dual stage cooling effect upon the air flow. Different combinations of internal parts provide diversity in operation with different cooling mediums. These and other unique features of the system are discussed below and illustrated in the accompanying drawings.

The system will be understood, both as to its structure and operation, from the accompanying drawings, taken in conjunction with the accompanying description. Several embodiments of the assembly are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

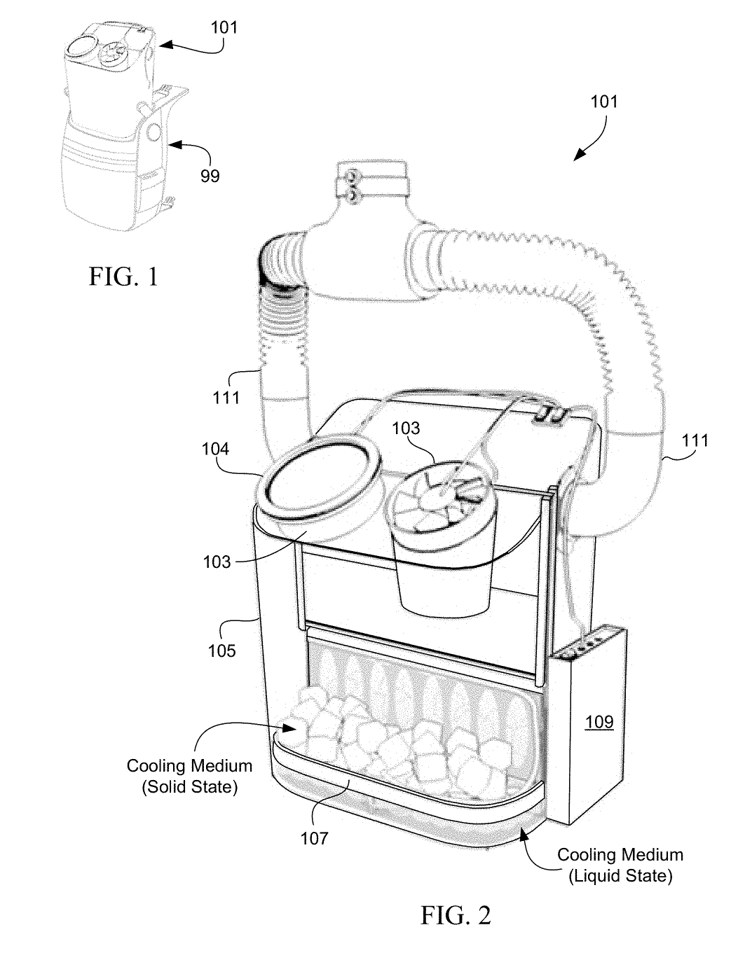

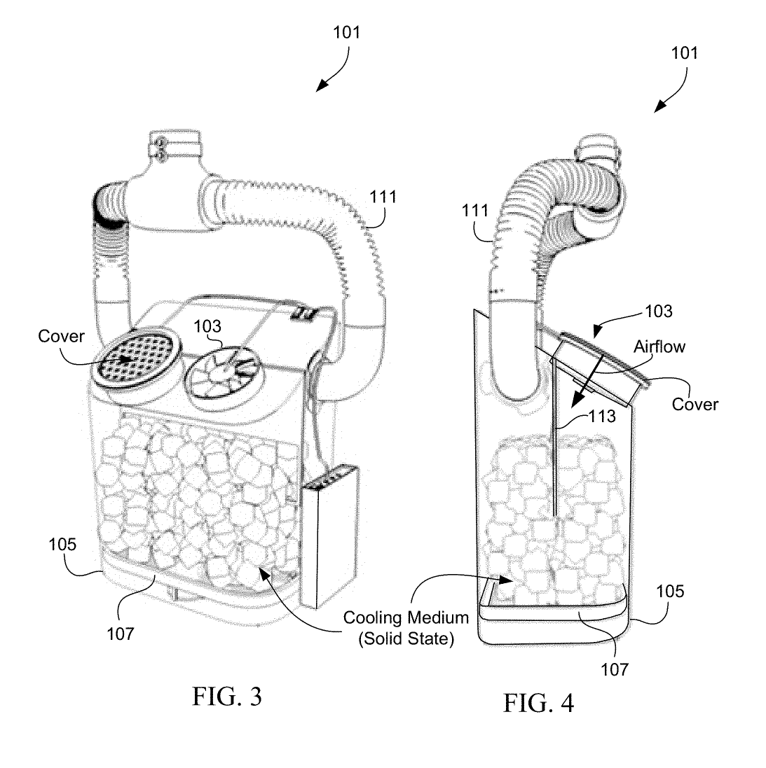

Referring now to the figures wherein like reference characters identify corresponding or similar elements in form and function throughout the several views. Referring now to FIGS. 1 and 2 in the drawings, perspective views of a portable air cooling unit 101 is illustrated. Unit 101 is designed to provide a larger and longer lasting cooling device compared to hand held fans. Unit 101 may be carried by a user via known carrying devices. For example, FIG. 1 illustrates unit 101 within a bag 99. Bag 99 may include straps for attachment to an individual or an object. An purpose of unit 101 is to provide hands free cooling for an individual.

FIG. 2 provides a more detailed perspective view of unit 101. Unit 101 includes a fan unit 103, a storage unit 105, an internal tray 107, a power supply 109 and an exhaust duct 111. Fan unit 103 is configured to generate an air flow that passes through storage unit 105 and eventually leaves through flexible exhaust duct 111. Within storage unit 105, the air flow is subjected to one or more cooling mediums to remove heat from the air flow. The matter state of the cooling mediums may be either liquid and/or solid. Examples of cooling mediums may be liquid water or ice. An operator may use just ice, wherein eventually it melts and become water, thereby having two cooling mediums for a time. Alternatively, and operator may elect to begin the cooling process with two cooling mediums. It is understood that ice and water are not the only forms of cooling mediums, however they are customarily the most accessible and will be used in this description to illustrate the operation of unit 101. Internal tray 107 is located within storage unit 105 and translated therein in response to the matter state of the cooling mediums. Power supply 109 selectively provides electrical power to operate fan unit 103.

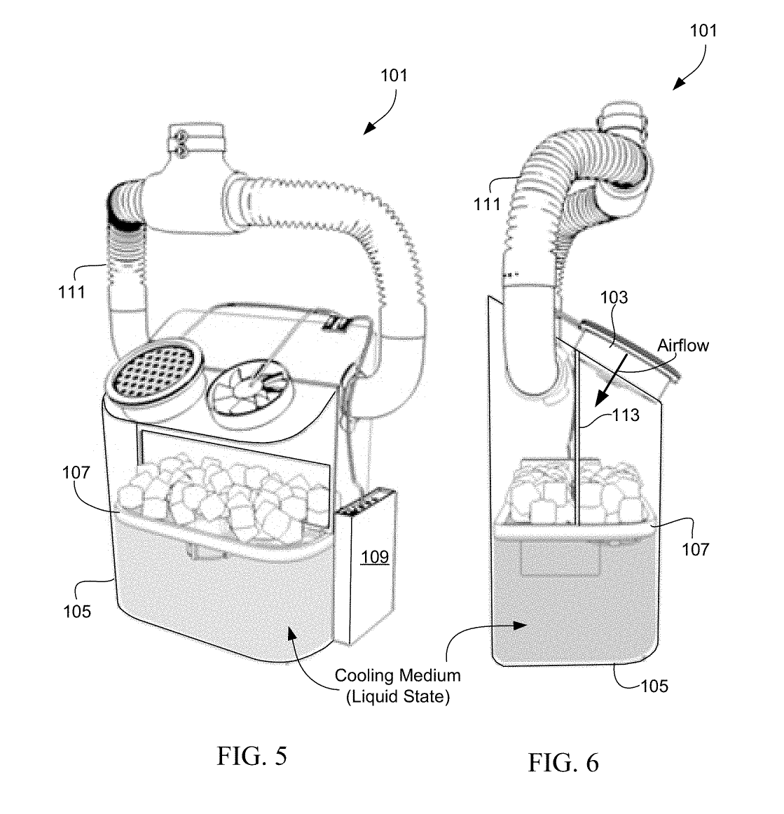

It is understood that a plurality of fans may be used in fan unit 103. Fan unit 105 is designed to draw in a volume of air and force that air into storage unit 105. Storage unit 105 is a sealed unit except for the inlet of air and the outlet of air that are designed to be fan unit 103 and exhaust duct 111, respectively. A cover 104 is illustrated over a particular fan. Cover 104 may be designed to either seal off air flow (see FIG. 1) through the respective fan or may be used to have one or more apertures or slots (see FIG. 3) to serve as protection from injury and damage if debris reached the fan.

The following figures will be used to illustrate various functions and features of unit 101. Some of these will reflect user preferences in the method and manner in using unit 101. Referring now also to FIGS. 3-6 in the drawings, an exemplary embodiment of unit 101 is illustrated in various views. As stated previously, a user may use differing combinations of cooling mediums to remove heat from the air flow. In FIGS. 3-6, ice is the initial cooling medium used. Liquid water may also have been used in the configuration.

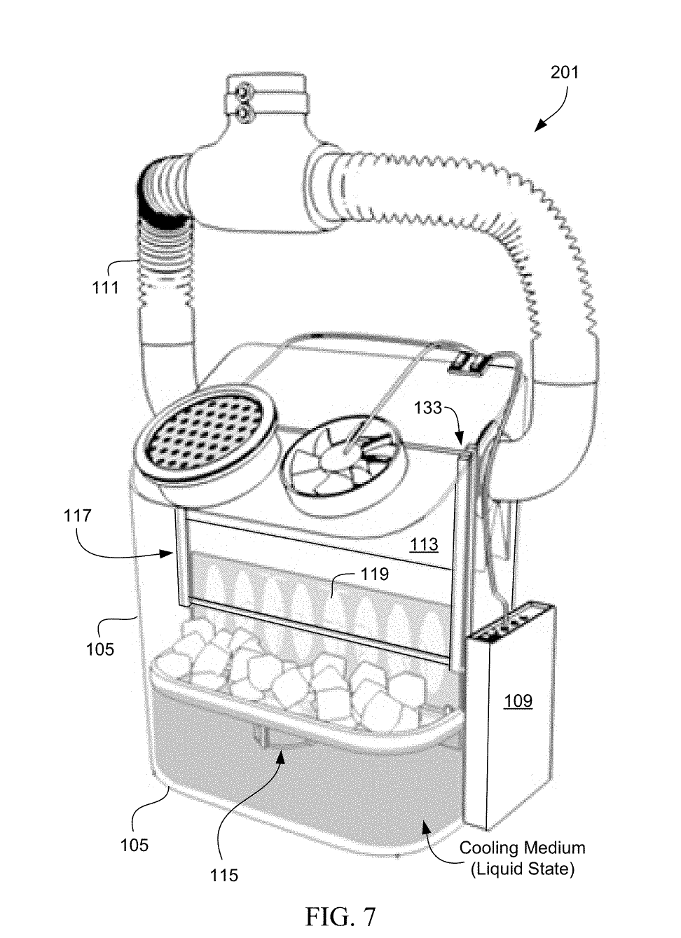

Unit 101 further includes internal tray that is configured to separate solid forms of the cooling medium from liquid forms of the cooling medium. To accomplish this, tray 107 is configured to rise and fall with the level of liquid in storage unit 105. Tray 107 is configured to float across the surface of the liquid cooling medium (if existing) and at the same time elevate the solid cooling medium above the liquid surface. A purpose of unit 101 is to provide a dual stage cooling effect upon the air flow within storage unit 105. Air flow is passed through the solid cooling medium and subsequently brought into contact with the liquid cooling medium prior to exiting out duct 111. As evident through inspection of FIGS. 3 and 4, when a user begins with just a solid cooling medium, only a single cooling stage process occurs. However, over time the solid cooling medium melts and begins to fill the bottom of storage unit 105. As the liquid level rises, tray 107 rises accordingly (see FIGS. 5 and 6). Tray 107 is also configured to maintain an air gap between the solid cooling medium and the bottom surface of storage unit 105. This allows the dual stage cooling process/effect to begin as soon as liquid cooling medium is created.

Unit 101 may further include a divider 113 which is coupled to storage unit 105 and designed to separate or designate two distinct areas of storage unit 105. In the present configurations, divider 113 will be seen to run along the width of the interior of storage unit 105 and thereby designate a forward half and a rear half within. A particular design feature of unit 101 is that the inlet to storage unit 105 is in a separate half to that of the outlet. This is seen with fan unit 103 being located in the forward half and duct 111 being located in the rear half. It is worth mentioning at this stage that fan unit 103 does not have to be located in the inlet portion of storage unit 105. Fan unit 103 may be configured to push an air flow into storage unit 105 by being located in the inlet portion of storage unit 105. Alternatively, fan unit 103 may be configured to pull or draw in an air flow through storage unit 105 by being located in the same half as the outlet portion or any location along the length of duct 111. Divider is shown as being perpendicular to tray 107 and to permit the selective passage of air flow between the halves of storage unit 105.

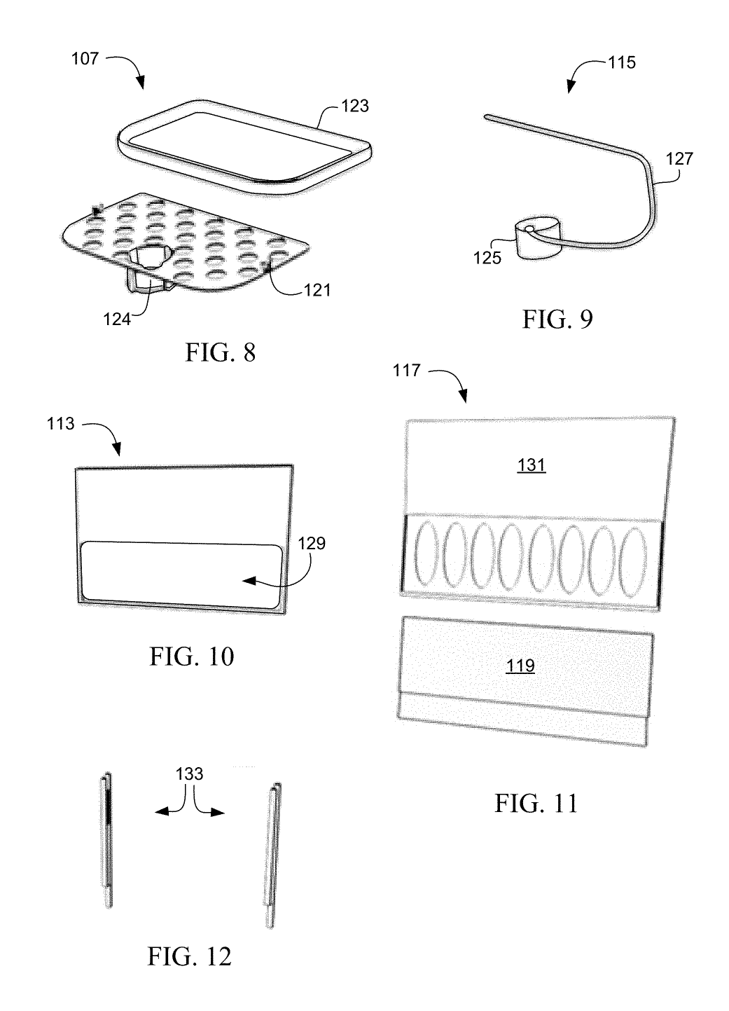

Referring now also to FIGS. 7-14 in the drawings, an alternative embodiment of unit 101 is illustrated. FIG. 7 is a perspective view of portable air cooling unit 201 which is similar in form and feature of unit 101. Unit 201 differs in that it includes additional components within the interior of storage unit 105 to further enhance the dual stage cooling process. Cooling unit 201 further includes a pump 115 and a mesh assembly member 117. Pump 115 is configured to distribute the liquid cooling medium across a mesh 119 of member 117. The distributed liquid cooling medium saturates mesh 119. Wherein unit 101 permitted air flow to pass through the solid cooling medium and across the surface of the liquid medium to achieve the dual stage cooling process, unit 201 further enhances this process by including mesh 119 and pump 115. Air flow is now also passed through a portion of the liquid cooling medium that is residually saturating mesh 119, thereby lowering the temperature of the air flow further.

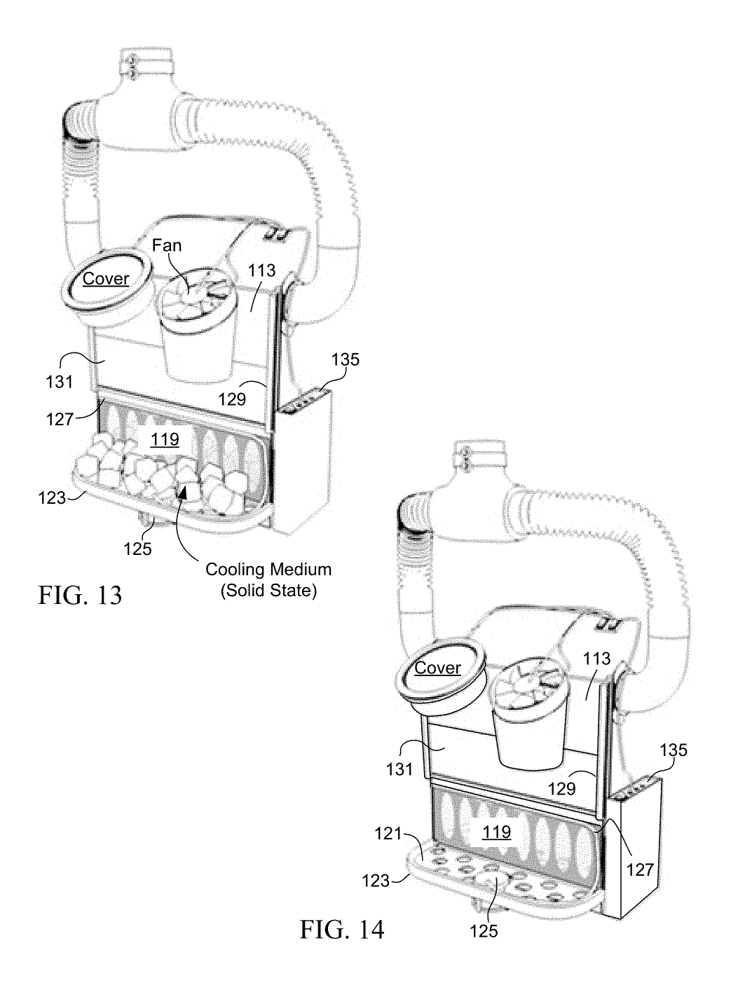

FIGS. 8-12 in particular provide enlarged detailed views of the interior components of unit 201. In FIG. 8, tray 107 is shown in greater detail. Tray 107 is designed to include one or more holes of varied sizes. The holes allow liquid to fall down below tray body 121. Tray body 121 is also configured to house pump 115 within a defined recess 124. Tray 107 also includes a trim 123 that passes around a portion of the perimeter of tray body 121. Trim 123 fills the gap around the perimeter of tray body 121 with that of the side panels of storage unit 105. Trim 123 may also help to minimize friction therebetween. Additionally, trim 123 may also be configured to float which in turn acts to lift tray body 121 to the surface of the liquid cooling medium.

In FIG. 9, pump 115 is illustrated. Pump 115 is configured to have a motor 125 and a tube 127. Motor 125 draws in the liquid cooling medium and transfers such medium through tube 125 into contact with mesh 119. Pump 115 is in electrical communication with power supply 109. FIG. 10 provides an enlarged perspective view of divider 113. Divider 113 is a relatively flat and solid component. Divider 113 is configured to be secured within storage unit 105 such that divider 113 does not move as tray 107 moves. Divider 113 stays fixed in relation to storage unit 105. Divider 113 includes an aperture 129 to selectively permit air flow to pass therethrough. Divider was seen in Unit 101 as well as Unit 201. The nature and location of aperture 129 being generally on the lower portion of its body is to help ensure that the air flow has to pass down through at least a portion of the solid cooling medium prior to transitioning through duct 111. If divider 113 was too low in storage unit 105, the surface level of the liquid cooling medium could theoretically rise above aperture 129 and act as a full or complete restriction of air flow. Divider 113 is suspended above the lower surface of storage unit 105 a set distance. The distance is determined as a sufficient distance such that the melting of a full load of solid cooling medium would not create a full restriction of air flow.

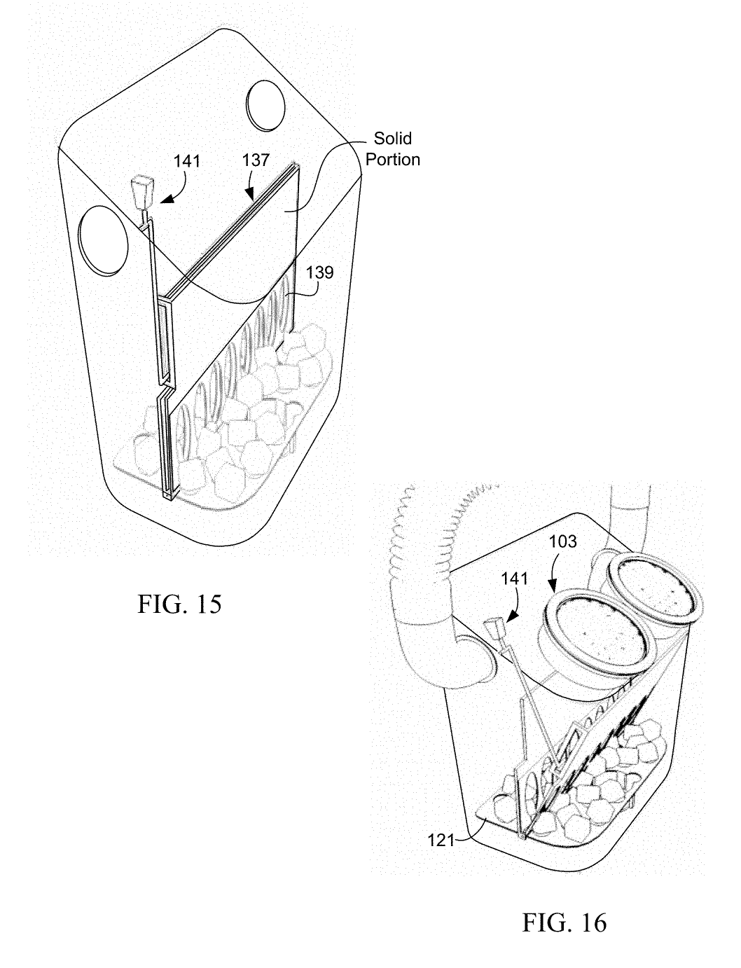

Mesh assembly member 117 is shown more clearly in FIG. 11. Mesh assembly member 117 includes mesh 119 and a partition 131. Partition 131 is configured to support mesh 119 and is coupled to tray 107. As tray 107 moves with the level of the liquid cooling medium, mesh assembly member 117 also moves in like manner. Member 117 is configured to pass adjacent to and along a side of divider 113. A pair of supports 133 (see FIG. 12) are provided to ensure proper support and spacing of divider 113 and member 117. As seen in FIG. 11, partition 131 includes one or more openings along its lower edge. Above the openings, partition 131 is a solid sheet similar to that of divider 113 above aperture 129. Mesh 119 is configured to spread across the openings of partition 131. Mesh 119 may be secured in any known method common for such a purpose.

FIGS. 13 and 14 are useful in seeing a clearer view of the internal components of storage unit 105 (removed for clarity). In these Figures, tray 107 is located at its lowest point. The solid cooling medium is still pictured in FIG. 13, but is removed for better clarity in FIG. 14. Motor 125 is seen in tray body 121. Tube 127 is shown extending therefrom and reaching up and over mesh 119. Tube 127 may be coupled to a portion of member 117. Liquid cooling medium is distributed across mesh 119. A control panel 135 is provided to permit a user control of the electrical portions of units 101 and 201.

Control panel 135 is configured to provide on/off capability to fan unit 103 and pump 115. Additionally, control panel 135 is further configured to optionally automate operation of either fan unit 103 and pump 115 based upon one or more environmental parameters. An example of an environmental parameter may include at least any of the following: detecting the presence and level of liquid cooling medium so as to automatically turn on/off pump 115, and the ascertaining of the ambient air temperature so as to regulate the speed of fan unit 103. These functions may be facilitated by the use of one or more sensors in electrical communication with control panel 135.

As further seen, in this position with tray 107 at its lowest point in storage unit 105, partition 131 blocks/restricts aperture 129 of divider 113. This helps to force the air flow down through the solid cooling medium so as to pass through mesh 119. This ensures a dual stage cooling process. In operation, as tray 107 rises with the liquid cooling medium level, member 117 also rises. Referring now back to FIG. 7 in the drawings, a perspective view of unit 201 having a mixture of solid cooling medium and liquid cooling medium is illustrated. As seen clearly in this Figure, as tray 107 rises, partition 131 passes beyond aperture 129 as mesh 119 passes within aperture 129. Tray 107 and member 117 are configured to ensure that liquid cooling medium below tray 107 does not flood/fill mesh 119, and that air flow is always able to pass through mesh 119. Partition 131 selectively restricts the passage of air flow through aperture 129 which in turn functions to ensure air flow passes through mesh 119.

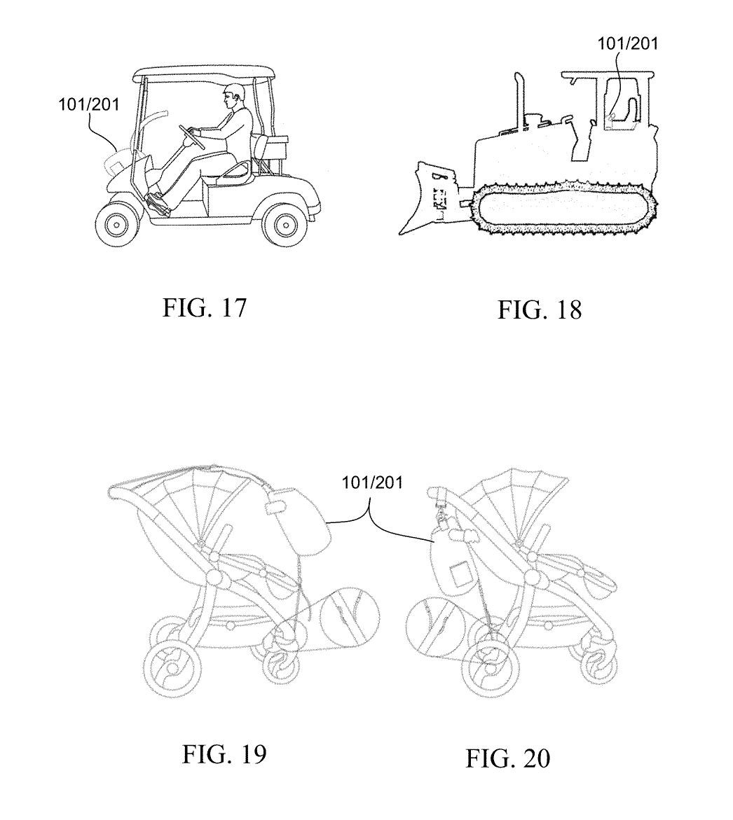

Referring now also to FIGS. 15 and 16 in the drawings, perspective views of a barrier 137 are illustrated. Barrier 137 can be used in place of divider 113 and member 117 described previously. Barrier 137 is releasably coupled to storage unit 105 and is positioned therein similarly to that of divider 113, thereby defining two halves. Barrier 137 includes one or more holes 139 along a lower edge. These holes act similar to the holes/openings associated with member 117. Air flow is forced to flow down through the solid cooling medium and through holes 139 to transfer between halves of storage unit 105. Use of barrier 137 is ideal with unit 101 or when there is not expected to by much if any liquid accumulation. For example, storage unit 105 in some embodiments may include a drain plug configured to permit selective draining or a continuous draining of liquid from storage unit 105. This would maintain only solid cooling medium within the storage unit. Barrier 137 is further configured to selectively pivot, thereby separating two portions of its body. The pivoting portion is useful in redirecting the air flow away from a portion of storage unit 105. As seen in FIG. 16, a front portion of barrier 137 is pivoted forward. The non-holed section of barrier 137 (upper portion) acts to deflect air flow away from the solid cooling medium. This can help to increase the lifespan of the solid cooling medium. It is noted that there remains a vertical portion of barrier 137 that is maintained in its original alignment. This maintains the defined division of halves within the storage unit. To operate barrier 137, a user may manually adjust a handle 141. Handle 141 may be accessible to a user from inside or outside storage unit 105.

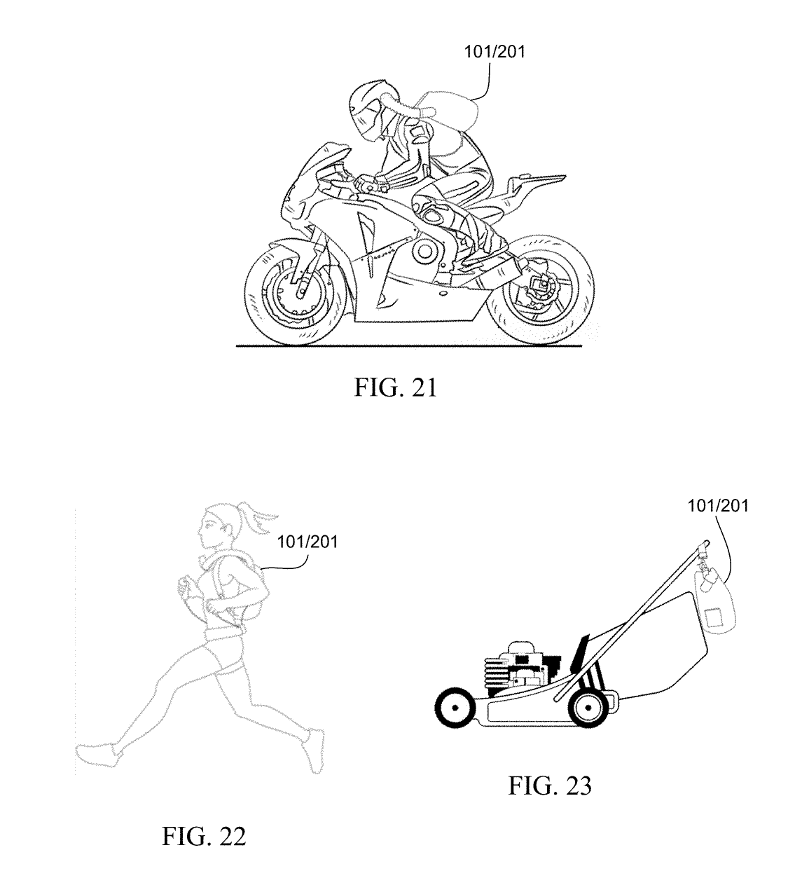

Referring now also to FIGS. 17-23, various uses of units 101/201 are depicted in different ways. It is understood that units 101/201 may or may not be worn by the user. Bag 99 may include straps that assist in securing unit 101/201 to users and/or machinery or any device. For example, unit 101/201 may be secured to a golf cart (FIG. 17), a tractor (FIG. 18), a stroller (FIGS. 19-20), a lawn mower (FIG. 23), and to a user going for a run (FIG. 22) or going for a ride (FIG. 21). Unit 101/201 may include bag 99 to assist in facilitating desired uses by the user.

It is also important to note that power supply 109 is configured to receive power from any type of power generating device. Although supply 109 is rechargeable and can operate under its own stored power, power supply 109 may also run by providing power directly through some power generating device. Examples of such generating devices may be a generator, an automobile or other vehicle, an ATV, any motion driven power generation device whether generated through the movement of an individual or through the movement of a vehicle, and a home outlet for instance. Other examples exist.

The current application has many advantages over the prior art including at least the following: (1) dual stage cooling process upon the air flow; (2) mixed use of cooling mediums while ensuring a continuous amount of air flow; (3) ability to reach cooler temperatures and longer lasting; and (4) hands free use.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A cooling system, comprising:
a fan unit configured to generate an air flow;
a storage unit configured to receive the air flow from the fan unit, the storage unit configured to hold one or more cooling mediums;
an internal tray located within the storage unit and configured to translate within the storage unit in response to the matter state of the one or more cooling mediums;
a power supply configured to provide electrical power to operate the fan unit;
an exhaust duct configured to receive the forced air from the fan unit after passing through the storage unit, the exhaust duct configured to selectively direct the air flow.

2. The cooling system of claim 1, wherein the internal tray is configured to separate solid forms of one or more cooling mediums from liquid forms of the one or more cooling mediums.

3. The cooling system of claim 2, wherein the internal tray is configured to float on the liquid cooling medium.

4. The cooling system of claim 2, wherein the air flow is passed through the solid form of the one or more cooling mediums prior to passing across the liquid form of the one or more cooling mediums.

5. The cooling system of claim 1, wherein the internal tray is configured to rise and fall with the level of a liquid cooling medium.

6. The cooling system of claim 1, further comprising:
a pump and a mesh member in communication with the internal tray; the pump configured to distribute a liquid cooling medium across the mesh member, the mesh member including a mesh and a partition.

7. The cooling system of claim 6, wherein the mesh member and the pump move in conjunction with the movement of the internal tray.

8. The cooling system of claim 6, wherein the pump is selectively operated by a control panel, the control panel configured to automatically operate the pump based upon an environmental parameter.

9. The cooling system of claim 6, wherein the air flow is passed through the saturated mesh to lower the temperature of the air flow.

10. The cooling system of claim 6, further comprising:
a divider perpendicular to the internal tray and coupled to a portion of the storage unit, the divider has an aperture to selectively permit air flow to pass therethrough.

11. The cooling system of claim 10, wherein the divider is configured to separate the storage unit into a first half and a second half.

12. The cooling system of claim 10, wherein the partition selectively restricts passage of air flow through the aperture so as to require the air flow to pass through the saturated mesh prior to exiting the storage unit.

13. The cooling system of claim 1, further comprising:
a barrier releasably coupled to the storage unit, wherein the barrier passes through a portion of the interior of the storage unit.

14. The cooling system of claim 13, wherein the barrier includes an aperture configured to permit air flow to pass therethrough.

15. The cooling system of claim 13, wherein the barrier is configured to restrict flow of the air flow within the interior of the storage unit.

16. The cooling system of claim 13, wherein the barrier is configured to selectively pivot to restrict air flow in the storage unit.

17. The cooling system of claim 1, further comprising:
a control panel in communication with the power supply and the fan unit, the control panel configured to regulate the operation of the fan unit.

18. The cooling system of claim 1, wherein the exhaust duct is flexible.

19. The cooling system of claim 1, wherein the power supply is configured to receive power from a power generating device.
